(19) United States
(12) Patent Application Publication
(10) Pub. No.: US 2026/0288841 A1
(43) Pub. Date: Sep. 24, 2026

(54) SYSTEMS AND METHODS FOR GENERATING INVERSE SUMMARY DOCUMENTS

(71) Applicant: RELX Inc., Miamisburg, OH (US)

(72) Inventor: Michael Cole, New York, NY (US)

(73) Assignee: RELX Inc., Miamisburg, OH (US)

(21) Appl. No.: 19/085,427

(22) Filed: Mar. 20, 2025

(51) Int. Cl. G06F 16/34

(52) U.S. Cl. CPC G06F 16/345

(57) ABSTRACT

In one embodiment, a method of generating an electronic document includes receiving a source document, receiving a summary document of the source document, generating a residual model includes information present in the source document and not present in the summary document, receiving at least a portion of the residual model and at least a portion of the summary document by a trained model as an input, and outputting, by the trained model an inverse summary document, where the inverse summary document includes at least some information present in the source document but not present in the summary document.

### BACKGROUND

A document, such as a journal article, a legal brief, a legal decision and the like, is a language artifact having communicative intent. The text of the document conveys an author's ideas, event descriptions, experimental results, hypotheses, etc. There are many different ways to express the communicative intent, and therefore the communicative intent may be expressed in alternative documents.

One such document is a summary, which expresses the communicative intent of a source document in a shortened version. Thus, a summary, although expressing the same communicative intent as the source document, naturally includes less information (e.g., text, diagrams, and the like) than the source document. A useful summary is a one-to-one map to a source document. A summary is irreversible yet it is linked to the source document. In other words, presently it is not possible for a reader to read text or other information not present in the summary but found in the source document.

Accordingly, alternative methods of presenting source documents and summaries may be desired.

### BRIEF SUMMARY

In one embodiment, a method of generating an electronic document includes receiving a source document, receiving a summary document of the source document, generating a residual model includes information present in the source document and not present in the summary document, receiving at least a portion of the residual model and at least a portion of the summary document by a trained model as an input, and outputting, by the trained model an inverse summary document, where the inverse summary document includes at least some information present in the source document but not present in the summary document.

In another embodiment, a method of summarizing electronic documents includes receiving a plurality of summary documents of a plurality of source documents, receiving a plurality of residual models, where each residual model includes information present in an individual source document of the plurality of source documents and an individual summary document of the plurality of summary documents, receiving at least a portion of each residual model and at least a portion of each summary document by a trained model as an input, and outputting, by the trained model a plurality of inverse summary documents, where each inverse summary document includes at least some information present in an associated individual source document but not present in an associated summary document. The method also includes receiving at least a portion of the plurality of inverse summary documents by the trained model as an input. The method also includes outputting, by the trained model, a multi-document summary of the plurality of summary documents.

In another embodiment, a method includes presenting for display a summary document, receiving a query regarding the summary document, accessing, by a model, the summary document and a residual model, where the residual module includes information present in a source document associated with the summary document and not present in the summary document, and displaying an answer based on the query, the summary document, and the residual model.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates components of an inverse summary document according to one or more embodiments described and illustrated herein.

FIG. 2 illustrates a workflow for generating inverse summary documents according to one or more embodiments described and illustrated herein.

FIG. 3 illustrates a workflow for generating a multi-document summary document according to one or more embodiments described and illustrated herein.

FIG. 4 illustrates a computing device having a chatbot functionality according to one or more embodiments described and illustrated herein.

FIG. 5 illustrates a method for generating an inverse summary document according to one or more embodiments described and illustrated herein.

FIG. 6 illustrates a method for generating a multi-document summary document according to one or more embodiments described and illustrated herein.

FIG. 7 illustrates a method for generating a query for an answer against a summary document or an inverse summary document according to one or more embodiments described and illustrated herein.

FIG. 8 illustrates a computing device for generating inverse summary documents according to one or more embodiments described and illustrated herein.

### DETAILED DESCRIPTION

Embodiments of the present disclosure are directed to systems and methods of automatically generating inverse summaries of summary documents that are reflective of the original source documents for which the summaries are based on.

A summary document (also referred to herein as a “summary”) shares the same communicative intent as a source document yet typically with reduced information content. For example, a summary document may replace paragraphs of a source document with corresponding topic sentences or bullet points. Summary documents may be generated for different uses cases, purposes, or products. For example, a single source document may be summarized in multiple different ways. As a non-limiting example, a chief executive officer may receive a short summary of a long source document that includes just the high-level details because the time of the chief executive officer may be limited. On the other hand, a project manager may receive a summary of the same source document that is longer and includes more information while sharing the same communicative intent as the summary document provided to the chief executive officer.

A common inclination is to view summarizing as a kind of distillation of the source document. However, another perspective is to view summarizing as moving elements of the source document from “keep” to “forget.” A source document may be represented as a composition of a summary and the forgotten elements. Those elements moved to “forget” are not included in the summary document. Thus, summarizing is a sophisticated forgetting and rewriting process.

A useful summary is a one-to-one map of communicative intent to a source document. However, a useful summary is not a one-to-one map of particular text to a source document. As a reader usually engages the semantics of a document, there is no fundamental difference to the user between communicative intent and text. Thus, it is reasonable to believe there is a path from the summary document to the source document. Previously there was no such road map from a summary document back to the source document.

It may be beneficial for a user to receive an inverse summary of a summary document. As used herein, and “inverse summary” or “inverse summary document” is a document that is derived from a summary document that includes additional text or other information that is present in the source document but not present in the summary document. A helpful way to view summaries and inverse summaries is to think of a summary as a “dehydrated” version of a source document, and an inverse summary is a “rehydrated” version of the summary.

Embodiments of the present disclosure provide systems, methods and computer products for producing inverse summary documents that are derived from summary documents. As noted above, to summarize is to move elements from “keep” to “forget.” To inverse summarize (“summarize⁻¹”) is to move elements from “forget” to “keep.” Embodiments of the present disclosure store the forgotten elements in a residual model, and use the forgotten elements in the residual model along with the summary to produce an inverse summary document that is reflective of the source document. Thus, the inverse summary document will share the same communicative intent as both the summary document and the source document, but include additional information that is not included in the summary document but is present in the source document. It is noted that the inverse summary document, being a “rehydrated” version of the summary document, will not be an exact duplication of the source document; however, the inverse summary document will have more textual information closer to the source document than to the summary document.

Embodiments of the present disclosure improve over present document systems as the required computer storage is reduced as only the summary documents and the residual models need to be stored. The inverse summary documents can be used in a myriad of products. As one example, a single summary document can produce different inverse summary documents depending on the use case, as described above in the chief operating officer and product manager examples. In another example product, a legal researcher may have particular preferences as to how he or she receives summaries when performing legal research. These preferences may be stored in user profile that is accessed by the inverse summary system such that the user is presented with both a summary of a legal document and a longer, more robust inverse summary document that is tailored to the user's preferences. As another example, the residual model may be used by a chatbot or other model that allows the user to query against a summary document or inverse summary document. Because the system has access to the forgotten elements in the residual model, the chatbot can access this information and answer queries appropriately. As yet another example, residual models may be cryptographically wrapped and provided to third parties for their use in their own computing environments.

Various examples of systems, methods and computer products for generating inverse summary documents are described in detail below.

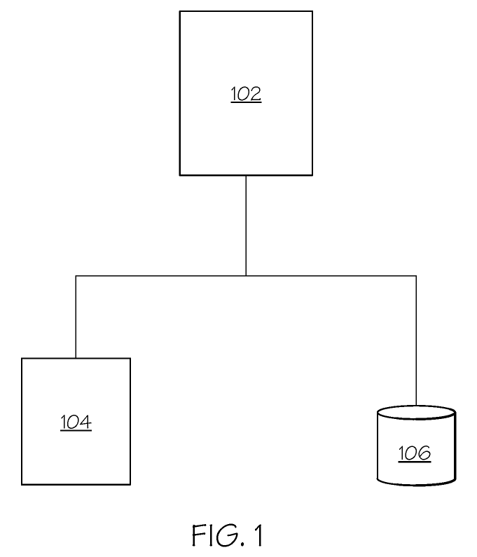

Referring now to FIG. 1, a source document 102 is illustrated. The source document 120 may be any electronic document such as, without limitation, a journal article, a legal brief, a legal decision, a business report, and any other type of electronic document having text with communicative intent. The electronic document may include textual content, as well as other types of information, such as, without limitation, graphs, plots, charts, drawings, photographs, and tables.

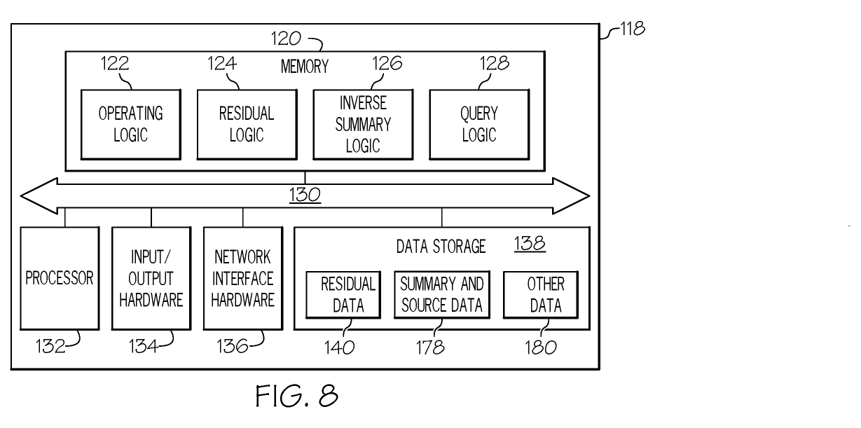

The source document 102 is comprised of information within a summary document 104 104 and forgotten elements stored in a residual model 106. The summary document shares the same communicative intent as the source document 102 but includes less text as the summarization process moves elements from “keep” to “forget.” In embodiments, the forgotten elements moved from “keep” to “forget” are not truly forgotten as they are stored in the residual model 106 as residual data 140 (see FIG. 8) for later use. It may be beneficial to store the forgotten elements in the most compressed manner possible to increase the portability of the residual model 106 and reduce storage requirements. The format of the residual data 140 stored in the residual model 106 may take on many forms. In a simple example, the forgotten elements may be list of elements textually stored in the residual model 106.

As another example, the forgotten elements may be encoded such that the residual data 140 is in the form of a graph. One such graph is a structure of the sequence of the source document text passages, where the nodes contain salient semantic elements, such as details about the subjects or objects of sentences, or the actions in the passage. Higher level semantic objects, such as “event” descriptions, or instances of semantic frames, can be accommodated.

As an illustrative, but non-limiting example, the graph can encode details and generalization at several levels in the graph structure, for example as subgraphs of a concept with associated details and subgraphs of relationships between concepts as used in source text. This illustrates one way in which the residual model preserves aspects of the communicative intent and also enables the production of a summary at different levels. Any element or elements, without respect to generalization or abstraction level, may be selected to be forgotten and captured in the residual model, or inversely, added to the summary. Such selection and production processes may be accomplished by applying a personalization or other context in which a 'forgetting' function is applied.

One example of an encoding process is to identify text characteristics that relate to source document details by applying NLP models to identify entities with their type, e.g., a TIME entity, or an ORGANIZATION, etc. More complex semantic elements can be extracted for graph encoding using functions over word sequences, such as n-grams, sentences, clauses, paragraphs, or other text units, including ones determined by logical ordering of the text. For example, by applying parts of speech (POS) tags to sentence words, processing dependency parses, etc. Any model can be used to process the source and make classifications that supply the encoding to graph nodes or structure the graph as relationships. These include models that accept texts, images, diagrams, audio, knowledge representations, including knowledge graphs, or other information representations.

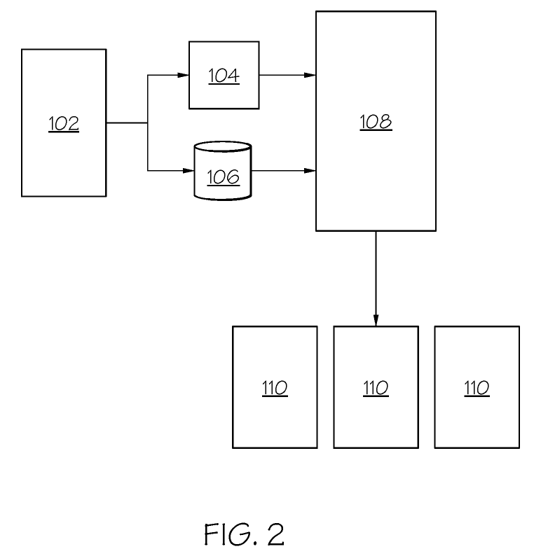

FIG. 2 illustrates a workflow for producing a plurality of inverse summary documents 110 from a single source document 102. Starting from the source document 102 on the left of FIG. 2, the source document 102 is summarized to produce a summary document 104. In some embodiments, the forgotten elements are saved as residual data and stored in the residual model 106 during or just after the summarization process. As a non-limiting example, the summary process may be performed by a trained model, such as a large language model. Any known or yet-to-be-developed large language model may be utilized such as, without limitation, GPT-3, GPT-3.5, GPT-4 and LLaMA. The large language model may be provided with prompt text to summarize the source documents 102 and store all information not included in the summary document 104 as residual data 140 in the residual model 106. In some embodiments, the prompt text is automatically generated from the residual model 106 and the summary document 104. In a subsequent process, an encoder may be used to store the residual data 140 as a graph in the residual model 106. In other embodiments, the residual data 140 produced by the large language model may be stored in in the residual model 106 as a text.

In other embodiments, an electronic compare process is performed between the source document 102 and the summary document 104 to extract the information that is within the source document 102 but not in the summary document 104 as forgotten elements. These forgotten elements are stored in the residual model 106 as residual data 140 in any form, such as text or a graph as described above.

To generate an inverse summary document 110, the summary document 104 and the residual data 140 stored within the residual model 106 are provided as an input to an inverse summary module 108. The inverse summary module 108 includes a trained model that is operable to generate an inverse summary document 110 from the summary document 104 and the residual data 140 stored within the residual model 106. As a non-limiting example, the trained model is a large language model capable of receiving the summary document 104 and the residual data of the residual model 106 as input (or otherwise accessing the summary document 104 and the residual data of the residual model 106), along with a prompt text that provides context as to how the inverse summary document 110 should be formatted and what types of, and how much, information should be included. Any number of inverse summary documents 110 of different contents and lengths may be produced. For example, a user may provide the inverse summary module 108 with a prompt to request additional information in a certain topic relating to the summary. As a non-limiting example, the prompt text may state “Prepare me a document about the July 2024 Sales Summary that provides more detail regarding sales in the Southeast Region.” The inverse summary module 108, which includes a trained model such as a large language model, then retrieves the summary document 104 and the residual data of the residual model 106 and produces an inverse summary document of the July 2024 Sales Summary that includes more information about sales in the Southeast Region. Other inverse summary documents 110 may be prepared for different audiences or use cases. As another example, some inverse summary documents 110 may be generated for internal use, while other inverse summary documents 110 may be generated for external use.

The residual data 140 stored in the residual model 106 may be cryptographically protected so that it can be provided to third party for third party applications. For example, the owner of the summary document 104 and the residual model 106 may be a data provider having clients. The owner may cryptographically protect the residual model 106 and provide it to a client so that residual model 106 can be used in the client’s own computing environment for only authorized purposes and also so that the client cannot obtain unrestricted access. In this manner, the summary documents 104 and the residual models 106 may be used by third parties in third party applications. Thus, embodiments make the summary documents 104 portable.

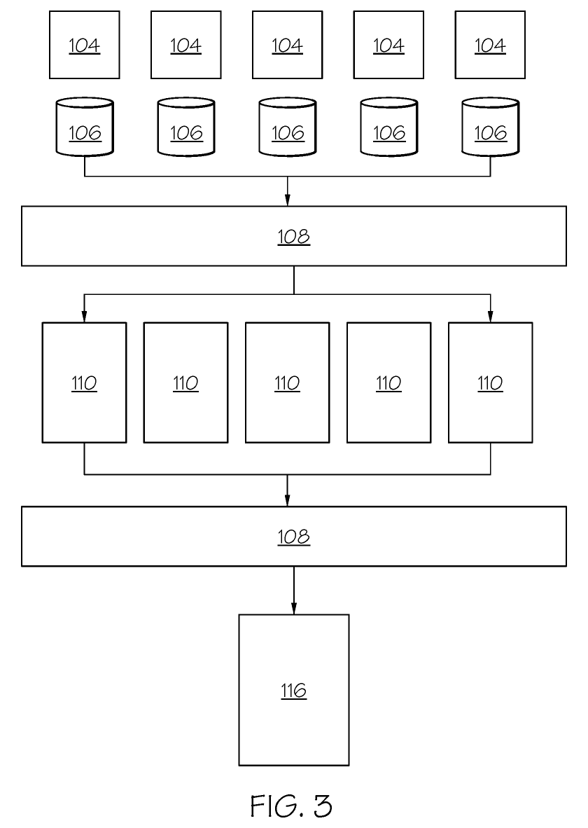

Referring now to FIG. 3, in some embodiments a plurality of summary documents 104 relating to a particular topic or topics may be summarized in a multi-document summary 116. This may be helpful in many applications. For example, a researcher may come across summaries relating to a certain medical condition while performing researching tasks. The system can expand each summary as inverse summary documents 110, and then summarize those inverse summary documents 110 as the multi-document summary 116.

As shown in FIG. 3, each summary document 104 has a residual model 106 associated therewith. The residual model 106 stores residual data 140 that includes the forgotten elements that are not present within the associated summary document 104 but included in the associated source document. These summary documents 104 and the residual data 140 of the residual models 106 are provided as input to the inverse summary module 108 along with a prompt that provides context as to the format of the desired inverse summary documents 110. All of the inverse summary documents 110 may be produced simultaneously, or sequentially.

The produced inverse summary documents 110 may then be provided as input along with prompt text to the inverse summary module 108, which is also programmed or otherwise configured to summarize the inverse summary documents 110. It is noted that in some embodiments a different trained model from that of the inverse summary module 108 is used to produce the summary. In other embodiments, the inverse summary module 108 can both produce the inverse summary documents 110 and produce summaries of multiple documents. It is also noted that, in addition to the inverse summary documents 110, full length source documents 102 may also be included in the batch of documents to be summarized. The output of the inverse summary module 108 (or other trained model) is a multi-document summary 116 that summarizes all of the content provided in the inverse summary documents 110, as well as any other additional documents provided as input.

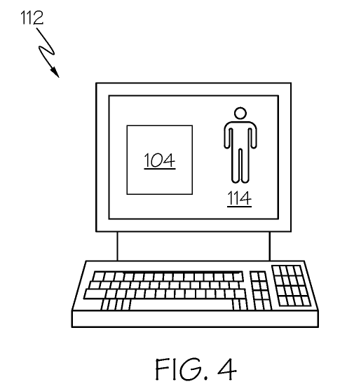

The forgotten elements of the residual data 140 stored within a residual model 106 also enable a user to query against a summary document 104 or an inverse summary document 110. Referring to FIG. 4, a user may access a summary document 104 (or inverse summary document 110) and a chatbot 114 on a computing device 112 to ask the chatbot 114 questions relating to the summary document 104 (or inverse summary document 110). The chatbot 114 may be any known or yet-to-be-developed chatbot 114 capable of receiving a query, accessing the summary document 104 and/or the inverse summary document 110 as well as the network interface hardware within the residual model 106, and providing an answer. The user may ask questions of the chatbot 114 regarding additional information that is not provided in the summary document 104 or inverse summary document 110. As a non-limiting example, the user can ask for additional information regarding data that is provided in charts that was originally provided in the source document 102. The chatbot 114 accesses this information in the residual model 106. The ability for the user to query against the summary document 104 or the inverse summary document 110 provides the user with confidence that the system is accurate and therefore increases trust.

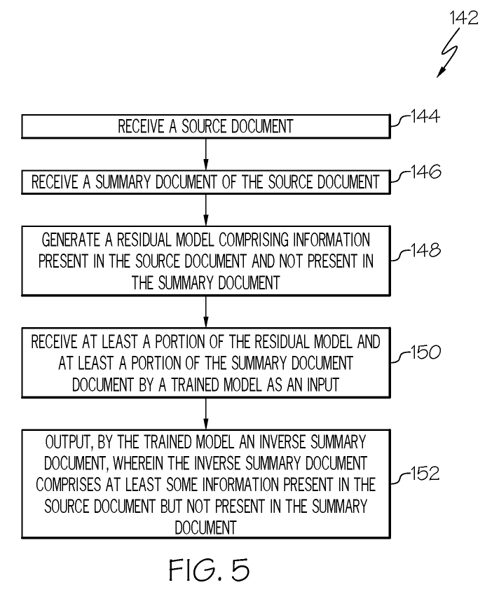

FIG. 5 illustrates an example method 142 of generating an inverse summary document 110. In block 144, the method 142 receives a source document 102, which may be an electronic document such as a journal article or legal document, as non-limiting examples. In block 146, the method 142 includes receiving a summary document 104 of the source document 102. The summary document 104 is a condensed/shortened version of the source document 102. In block 148, the method 142 includes generating a residual model 106 comprising information present in the source document 102 and not present in the summary document 104. This information is residual data 140 that includes forgotten elements of the source document 102 that are not provided in the summary document 104. In block 150, the method 142 includes receiving at least a portion of the residual data 140 of the residual model 106 and at least a portion of the summary document 104 document by a trained model as an input. In block 152, the method 142 outputs, by the trained model, an inverse summary document 110, wherein the inverse summary document 110 comprises at least some information present in the source document 102 but not present in the summary document 104. In other words, the inverse summary document 110 includes more detail than is present in the summary document 104. As stated above, the inverse summary document 110 can be tailored for the particular application and/or the particular preferences of the intended reader.

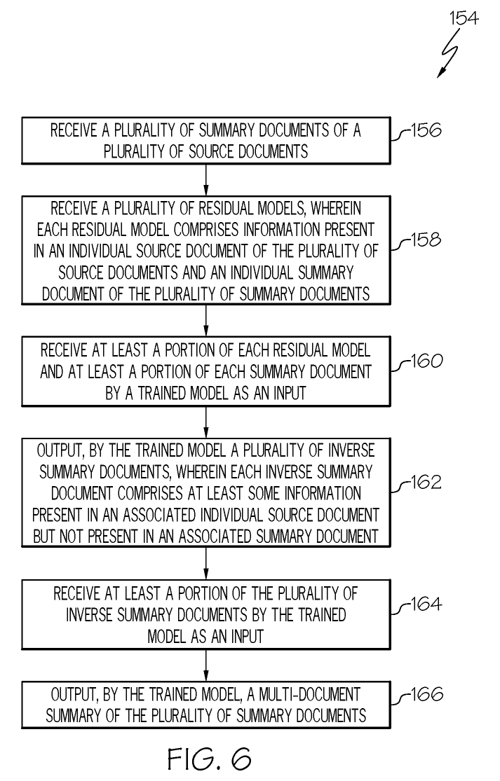

As described above with respect to FIG. 3, embodiments of the present disclosure are capable of summarizing a plurality of inverse summary documents 110. FIG. 6 illustrates a flowchart depicting a method 154 of summarizing a plurality of inverse summary documents 110. In block 156, the method 154 includes receiving a plurality of summary documents 104 of a plurality of source documents 102. In block 158, the method 154 includes receiving a plurality of residual models 106, wherein each residual model 106 comprises information present in an individual source document 102 of the plurality of source documents 102 and an individual summary document 104 of the plurality of summary documents 104.

In block 160, at least a portion of each residual model 106 and at least a portion of each summary document 104 is received by a trained model as an input. In 162, the method 154 comprises outputting, by the trained model, a plurality of inverse summary documents 110, wherein each inverse summary document 110 comprises at least some information present in an associated individual source document 102 but not present in an associated summary document 104. Thus, each inverse summary document 110 includes more detail than is present in its respective summary document 104. In block 164, the method 154 includes receiving at least a portion of the plurality of inverse summary documents 110 by the trained model as an input. In block 166, the trained model outputs a multi-document summary 116 of the plurality of summary documents 104.

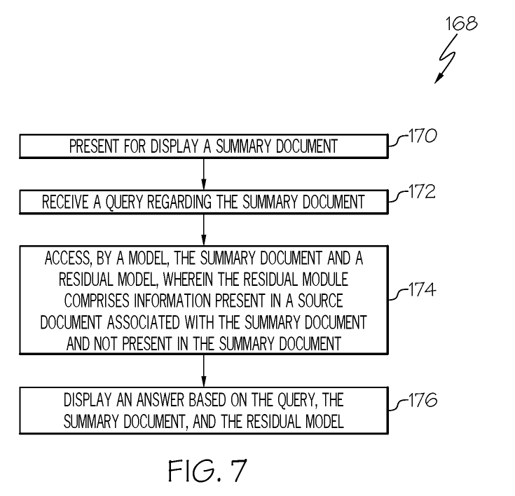

As described above with respect to FIG. 4, some embodiments include a chatbot 114 that allows a user to query against a summary document 104 or an inverse summary document 110. FIG. 7 illustrates a flowchart depicting a method 168 of answering a user's query against a document. In block 170, the method 168 includes presenting for display a summary document 104 (or an inverse summary document 110). In block 172, the method 168 includes receiving a query regarding the summary document 104 or inverse summary document 110. The method 168 further includes accessing, by a model, the summary document 104 or inverse summary document 110 and a residual model 106, wherein the residual module comprises information present in a source document 102 associated with the summary document 104 and not present in the summary document 104. In block 176, the method 168 includes displaying an answer based on the query, the summary document 104 or the inverse summary document 110, and the residual model 106.

Referring now to FIG. 8, an example computing device 118 for performing the functionalities described herein is schematically illustrated. The example computing device 118 provides a system for generating inverse summary documents 110 and other functionalities described herein, and/or a non-transitory computer usable medium having computer readable program code for generating inverse summary documents 110 and other functionalities described herein embodied as hardware, software, and/or firmware, according to embodiments shown and described herein. It should be understood that the software, hardware, and/or firmware components depicted in FIG. 8 may also be provided in other computing devices external to the computing device 118 (e.g., data storage devices, remote server computing devices, and the like).

As also illustrated in FIG. 8, the computing device 118 (or other additional computing devices) may include one or more processors 132, input/output hardware 134, network interface hardware 136, and a data storage component 138 (which may store residual data 140, summary and source data 178, and any other data 180 for performing the functionalities described herein), and a non-transitory memory component 120. The non-transitory memory component 120 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. In other embodiments, the memory component 120 may be defined by transitory memory and/or signals.

Additionally, the memory component 120 may be configured to store operating logic 122, residual logic for generating residual data 140 stored in a residual model, inverse summary logic 126 providing an inverse summary module including a trained model to generate inverse summary documents, and query logic 128 for providing chatbot functionality against a summary document or an inverse summary document (each of which may be embodied as computer readable program code, firmware, or hardware, as an example). It should be understood that the data storage component 138 may reside local to and/or remote from the computing device 118, and may be configured to store one or more pieces of data for access by the computing device 118 and/or other components.

A local interface 130 is also included in FIG. 8 and may be implemented as a bus or other interface to facilitate communication among the components of the computing device 118. The input/output hardware 134 may include an electronic display, a mouse, a touch screen, a microphone, a trackpad, a speaker, a camera, and any other device capable of producing output and receiving input from a user.

The processor 132 may include any processing component configured to receive and execute computer readable code instructions (such as from the data storage component 146 and/or memory component 120). The network interface hardware 136 may include any wired or wireless networking hardware, such as a modem, LAN port, wireless fidelity (Wi-Fi) card, WiMax card, mobile communications hardware, and/or other hardware for communicating with other networks and/or devices.

The components illustrated in FIG. 8 are merely exemplary and are not intended to limit the scope of this disclosure. More specifically, while the components in FIG. 8 are illustrated as residing within the computing device 118, this is a non-limiting example. In some embodiments, one or more of the components may reside external to the computing device 118.

It should now be understood that embodiments of the present disclosure provide systems, methods and computer products for producing inverse summary documents that are derived from summary documents. Embodiments of the present disclosure store forgotten elements in a residual model, and use the forgotten elements in the residual model along with the summary to produce an inverse summary document that is reflective of the source document. Additionally, embodiments of the present disclosure may also create a plurality of inverse summary documents, and then produce a summary of the plurality of inverse summary documents, providing the reader with a robust summary of many individual documents. In some embodiments, the system includes a chatbot feature that the user can engage to query against a summary document or inverse summary document to retrieve additional information not provided in the summary document or inverse summary document.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of generating an electronic document, the method comprising:
receiving a source document;
receiving a summary document of the source document;
generating a residual model comprising information present in the source document and not present in the summary document;
receiving at least a portion of the residual model and at least a portion of the summary document by a trained model as an input; and
outputting, by the trained model an inverse summary document, wherein the inverse summary document comprises at least some information present in the source document but not present in the summary document.

2. The method of claim 1, wherein the residual model is generated by comparing the source document with the summary document.

3. The method of claim 1, wherein the residual model comprises a knowledge graph.

4. The method of claim 1, wherein the trained model is a large language model.

5. The method of claim 4, further comprising generating prompt text from the at least a portion of the residual model and the at least a portion of the summary document, wherein the prompt text is the input to the large language model.

6. The method of claim 1, further comprising transmitting the residual model and the summary document from a first computing environment to a second computing environment.

7. The method of claim 1, further comprising receiving a use-case context by the trained model as the input.

8. The method of claim 1, further comprising:
receiving a query by a second trained model; and
providing, by the second trained model, an answer to the query based at least in part on the residual model and the summary document.

9. A method of summarizing electronic documents, the method comprising:
receiving a plurality of summary documents of a plurality of source documents;
receiving a plurality of residual models, wherein each residual model comprises information present in an individual source document of the plurality of source documents and an individual summary document of the plurality of summary documents;
receiving at least a portion of each residual model and at least a portion of each summary document by a trained model as an input;
outputting, by the trained model a plurality of inverse summary documents, wherein each inverse summary document comprises at least some information present in an associated individual source document but not present in an associated summary document;
receiving at least a portion of the plurality of inverse summary documents by the trained model as an input; and
outputting, by the trained model, a multi-document summary of the plurality of summary documents.

10. The method of claim 9, wherein the residual model is generated by comparing an individual source document with an individual summary document.

11. The method of claim 9, wherein the residual model comprises a knowledge graph.

12. The method of claim 9, wherein the trained model is a large language model.

13. The method of claim 12, further comprising generating prompt text from the at least a portion of each residual model and the at least a portion of each summary document, wherein the prompt text is the input to the large language model for output the plurality of inverse summary documents.

14. The method of claim 9, further comprising transmitting the plurality of residual models and the plurality of summary documents from a first computing environment to a second computing environment.

15. The method of claim 9, further comprising receiving a use-case context by the trained model as an input.

16. A method comprising:
presenting for display a summary document;
receiving a query regarding the summary document;
accessing, by a model, the summary document and a residual model, wherein the residual model comprises information present in a source document associated with the summary document and not present in the summary document; and
displaying an answer based on the query, the summary document, and the residual model.

17. The method of claim 16, wherein the model is a large language model.

18. The method of claim 16, wherein the residual model comprises a knowledge graph.

19. The method of claim 16, further comprising accessing a plurality of additional residual models, wherein the answer is further based on the plurality of additional residual models.

20. The method of claim 16, wherein the residual model is generated by comparing the source document with summary document.
